(19) United States
(12) Patent Application Publication
(10) Pub. No.: US 2019/0112168 A1
(43) Pub. Date: Apr. 18, 2019

(54) Power Bar for Winch

(71) Applicants: David R. Hall, Provo, UT (US); Daniel Madsen, Vineyard, UT (US); Benjamin Taylor, Provo, UT (US)

(72) Inventors: David R. Hall, Provo, UT (US); Daniel Madsen, Vineyard, UT (US); Benjamin Taylor, Provo, UT (US)

(21) Appl. No.: 15/784,481

(22) Filed: Oct. 16, 2017

(51) Int. Cl. B66D 1/28; B66D 1/58; B66D 1/46; B66D 1/12

(52) U.S. Cl. CPC B66D 1/28; B66D 1/58; H02J 7/0063; B66D 1/12; B66D 1/46

(57) ABSTRACT

A winch is described that includes a rotatable drum comprising a winch cable windably connected to the winch drum, and a removable vehicle winch frame. The winch comprises a winch motor, a gear assembly, and a power bar spanning the winch drum, the power bar being connected to an electrical power source and comprising an electrical power connection for powering auxiliary hardware. A winch controller comprising manual and app related software in communication with the motor, allows the controller to receive manual and or app related commands from a user to operate the winch assembly.

### FIELD OF THE INVENTION

This invention generally relates to winches, and more specifically relates to winches with improved functionality.

### BACKGROUND OF THE INVENTION

Winches in their most basic form have been used for many years to help hoist or move objects. Winches can be used in a variety of settings. They are used on boats, on cars, in a building, in a theatre, on a construction site, indoors or outdoors. They are extremely useful because they help users to maneuver often large or heavy equipment or materials in such a way that would be extremely difficult to do manually.

Winches are used to pull in or let out tension on a rope. There exists a wide variety of winches comprised of different materials. When using a vehicle such as an ATV, users are often in rough terrain, and far away from sources of electricity or power. In addition, they need the use of tools such as flashlights or other electronics such as a camera or a smart phone because of their practical features, such as the ability to make calls or take pictures or videos, and when using an ATV there are many situations that arise where an individual might wish to make a call, or take a picture. However, because these electronic devices have limited life span, they may run out of battery life before a user returns to a place that provides electric power. Thus, a winch that provides power and the ability to charge electronic hardware such as a flashlight, camera, or phone, is needed.

### SUMMARY

This invention has been developed in response to the present state of the art and, in particular, in response to the problems and needs in the art that have not yet been fully solved by currently available systems and methods. Features and advantages of different embodiments of the invention will become more fully apparent from the following description and appended claims, or may be learned by practice of the invention as set forth hereinafter.

Consistent with the foregoing, a system and method for a power bar smart winch are disclosed.

A winch is described that includes a rotatable drum comprising a winch cable windably connected to the winch drum, and a removable vehicle winch frame with two end brackets. The winch comprises a winch motor, a gear assembly, and a rigid power bar spanning the winch drum and connecting the first and second end brackets, the power bar being connected to an electrical power source and comprising an electrical power connection for powering auxiliary hardware. A winch controller comprising manual and app related software in communication with the motor, allows the controller to receive manual and or app related commands from a user to operate the winch assembly.

A clip is specifically designed which is comprised of a first end that attaches to the power bar, and a second that attaches to hardware. Various hardware can be attached to the clip and thereby to the power bar. There are various clips with distinct second ends to connect to the different hardware. The hardware consists of various dc powered handheld devices and once they are secured to the power bar by the clip, the power bar can charge the devices. Some examples of hardware that can be secured to the power bar are a flashlight, a camera, a mobile phone. However, non-electric hardware, such as a handle may also be connected to the power bar. In these instances, the non-electric hardware will not charge, but may prove convenient or helpful to the user.

The exterior surface of the winch drum is comprised of spiral grooves to control where the cable is placed on the drum when it is wound or unwound. They prevent the cable from winding onto itself or becoming tangled.

The winch frame may attach or detach to a variety of vehicles, and may also operate while unattached to any vehicle. For example, a winch could be attached to a boat, a truck, a car, a tractor, a motorcycle, or an ATV. The winch could be useful attached to any of those vehicles.

The cable may be comprised of a material that is sufficiently strong enough to pull up to 2,000 lbs. The most likely materials that the cable will be composed of are steel, polyethylene, fiber based polyethylene, and synthetic fiber.

In one embodiment, the gear assembly shifts electronically, so that it does not need to be manually shifted, and so that the user does not control when the gear assembly shifts. However, in another embodiment, a user may indicate via the app when they would like the gear assembly to shift electronically.

In another embodiment, the winch may have a cover for the power bar, to protect the power bar from damage. A power bar may be damaged by rain, snow, wind, mud, or ice. A cover for the power bar may be constructed from materials including silicone, rubber, or plastic or a combination thereof.

The all in and all out command included in the app related software permits a user to wind all the cable onto the drum at once, or to unwind the entire cable off of the drum at once.

The app related software includes a cable winding speed control so that a user can speed up or slow down the rate at which the cable winds onto or off the drum.

The drum comprises a load sensor for communicating the size of the load to the controller and the user.

The cable load threshold is up to 2,000 lbs., permitting the winch to wind an object that weighs up to 2,000 lbs.

The pairing button, when pressed or activated, has the ability to connect the controller to a nearby cellular device via a short-range wireless connection, so that the user can control the winch via their phone.

The user selectable presets available via the app related software permit a user to preset a length of cable they would like wound off of the drum.

The remote is plugged into the winch and may control the winch and its various adjustable features in the event that the user does not have or does not prefer to use a cellular device that can use the app related software for controlling the winch.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1A depicts a winch, according to some example embodiments, with a power bar;

FIG. 1B depicts a cross sectional view of a winch assembly;

FIG. 2 is an illustration depicting an auxiliary clip attached to a winch and holding a flashlight, according to one example embodiment;

FIG. 3 depicts an auxiliary clip attached to a winch and holding a camera, according to one example embodiment;

FIG. 4 depicts a winch with a power bar located on the front of the winch;

FIG. 5 depicts the winch of FIG. 1A attached to the front of an ATV, according to one embodiment;

FIG. 6 is a close-up view of the power bar and its cover, which shows a protective material encasing the power bar;

FIG. 7 is an illustration depicting an app on a mobile phone for the winch, with various features;

FIG. 8A depicts the winch of FIG. 1A with a remote plugged into the winch, according to one example embodiment;

FIG. 8B depicts a close-up view of the remote of FIG. 8A, which shows the different controls on the remote.

### DETAILED DESCRIPTION OF THE DRAWINGS

In the following detailed description, numerous specific details are provided for a thorough understanding of the various embodiments disclosed herein. The embodiments disclosed herein can be manufactured without one or more of the specific details, or with other methods, components, materials, etc. In addition, in some cases, well-known structures, or characteristics may be combined in any suitable manner in one or more alternative embodiments.

Battery powered winches are useful for many reasons. They are designed such that they do not need to be attached to a source of electric power at all times, rather they are portable and can operate without any attachment to an exterior source of electric power because the battery provides the needed power.

Depending on the environment in which a winch is used, other devices may be beneficial. One of the common use cases for winches, for example, is for a winch to be placed on a vehicle (e.g., all-terrain vehicle (ATV), truck, utility vehicle, and the like). Typically, the winch is placed at the front (or back) of the vehicle. This placement may also be ideal for lights, cameras, speakers, and the like. For instance, it may be beneficial to have a light(s) and/or a camera placed at the front (or back) of a vehicle. For example, to provide light or record the experience that the vehicle goes through.

It is appreciated, that many devices are battery powered—such as cell phones, lap tops, cameras, lights, and/or speakers. Battery powered devices, although convenient because of their portability, have the issue of a limited life span. Battery life varies depending on the size of the battery and the amount of energy a device requires. But eventually, battery powered devices will use all the power provided by the battery and then cease to function until the battery is recharged. Users of battery-powered devices must be conscious of how much battery power a device has when they are not using a device near an external source of electrical power. A battery powered winch, similarly, has a limited life span, but may have a battery which is much larger (and thus lasts much longer, for example) than those found in other battery powered objects such as a cell phone, laptop, camera, light, and/or speaker. Batteries may be recharged by other batteries, and thus a winch battery could be a source of energy for other battery-powered devices. Accordingly, a winch that includes the ability to both mount and power other devices may be beneficial.

A winch that includes a power bar for both mounting and optionally powering other devices is described herein. As described herein the power bar enables mounting and/or powering of one or more devices. For example, a video camera (such as an action camera, for example) may be mounted and powered via a power bar attached to the winch. In some embodiments, a power bar may have exposed electrical contacts for providing power to another device (e.g., light, camera, etc.). Additionally or alternatively, the power bar may have inductive coils for wireless power transfer, etc. Reference is now made to the figures, which further describe various embodiments of the described winch with power bar.

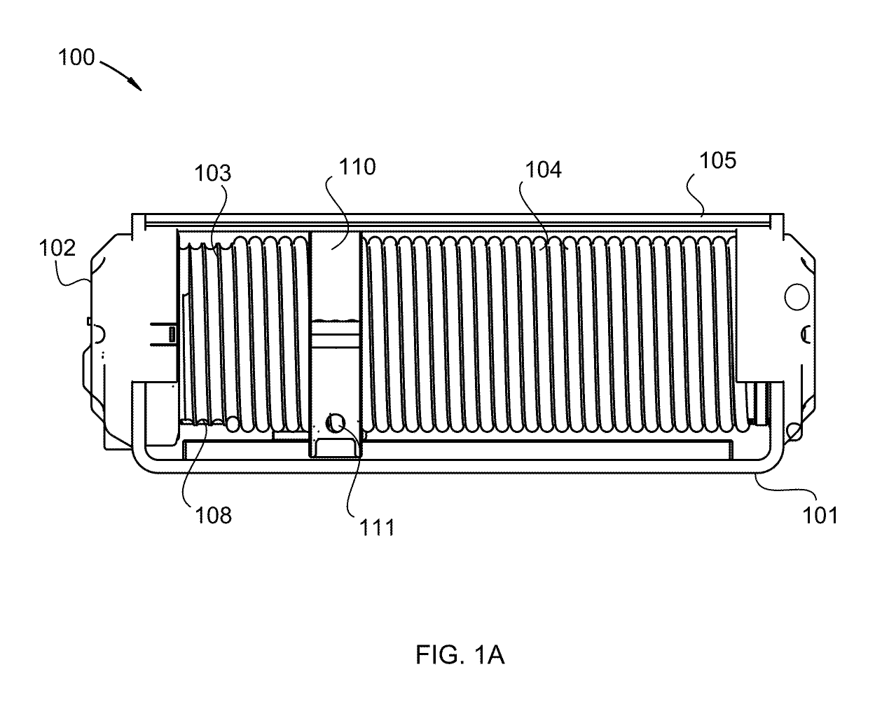

FIG. 1A depicts a winch 100, according to one embodiment, with a removable vehicle winch frame 101 and two end brackets 102. A winch drum 103 is disposed within the frame 101 and between and the end brackets 102. Attached to the winch drum 103 is a cable 104 which can wind and unwind on and off the drum 103. The cable 104 may be configured such that it may unwind off the drum 103 from left to right, or from right to left, via the guide 110 through a small hole on the guide 111, which prevents the cable 104 from tangling when winding on or off the drum 103. Attached to the winch end brackets 102 is a power bar 105 (e.g., rigid power bar 105), which is connected to an electrical power source and may power auxiliary equipment when desired. The power bar 105 may be attached (via bolts or rivets, for example) directly on top of the winch assembly 100, or it may be attached in front of or behind the winch assembly 100. The power bar 105 consists of cross bar that may be enclosed in a waterproof casing. The power bar 105 includes electrical contacts that run through at least a portion of the power bar and are wired into the battery. In some cases, the electric contacts may be coils of wire, which create a magnetic field (for inductive power transfer, for example). The electrical contacts may be copper or another electrically conductive material.

FIG. 1B is a cross-sectional view of the winch 100 of FIG. 1A, which shows the inner workings of the winch 100. A winch motor 106 is disposed inside the drum 103, and is attached to a gear assembly 107 and the winch drum 103. When the winch motor 106 and the gear assembly 107 operate together the winch drum 103 rotates, to either wind or unwind the cable 104. The drum 103 in many embodiments is shaped as a right circular cylinder; however, the drum 106 can be of any variety shapes including an elliptic cylinder, a parabolic cylinder, a hyperbolic cylinder, an oblique cylinder, a cuboid, a rounded cuboid, a triangular prism, and/or any of a variety of other shapes. In some embodiments, the drum 103 includes a plurality of helical grooves 108 to assist in uniformly winding the cable 104 onto the drum 103. A winch controller 109 comprises manual and app related software in communication with the motor, such that the controller 109 receives commands from a user and operates the winch assembly accordingly. As illustrated, the winch 100 includes a battery 112. In some embodiments, the battery 112 may be electrically coupled to and may power the power bar 105.

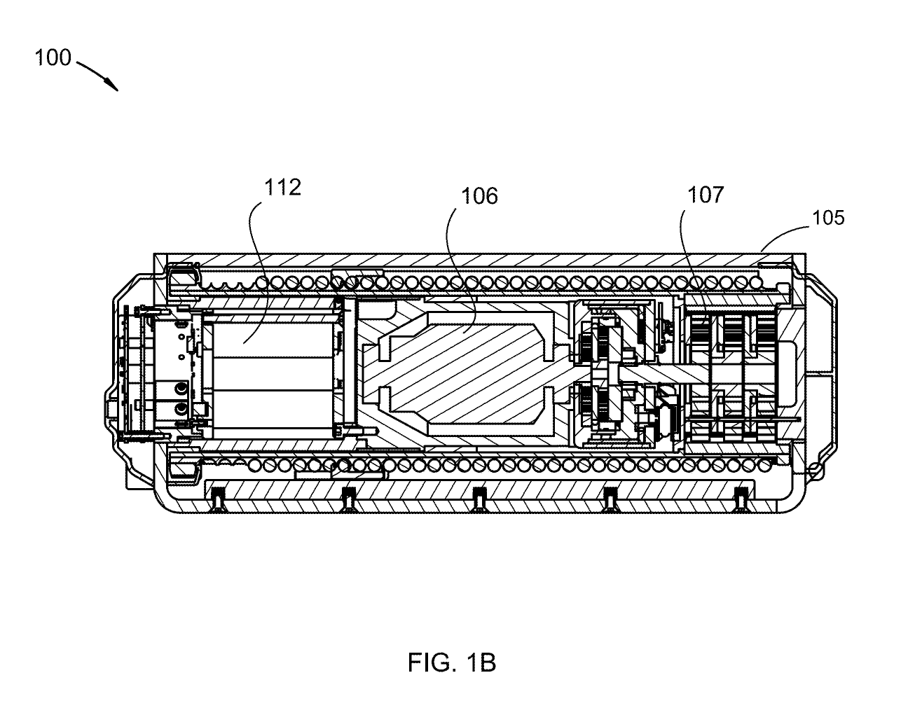

FIG. 2 is a front view of the winch 100 with an auxiliary clip 200 attached to the rigid power bar 105. The auxiliary clip 200 is connected to a flashlight 201. The auxiliary clip 200 latches onto the rigid power bar 105, and, by means of electrical power (e.g., alternating current (AC) or direct current (DC)) charges and/or powers the attached hardware.

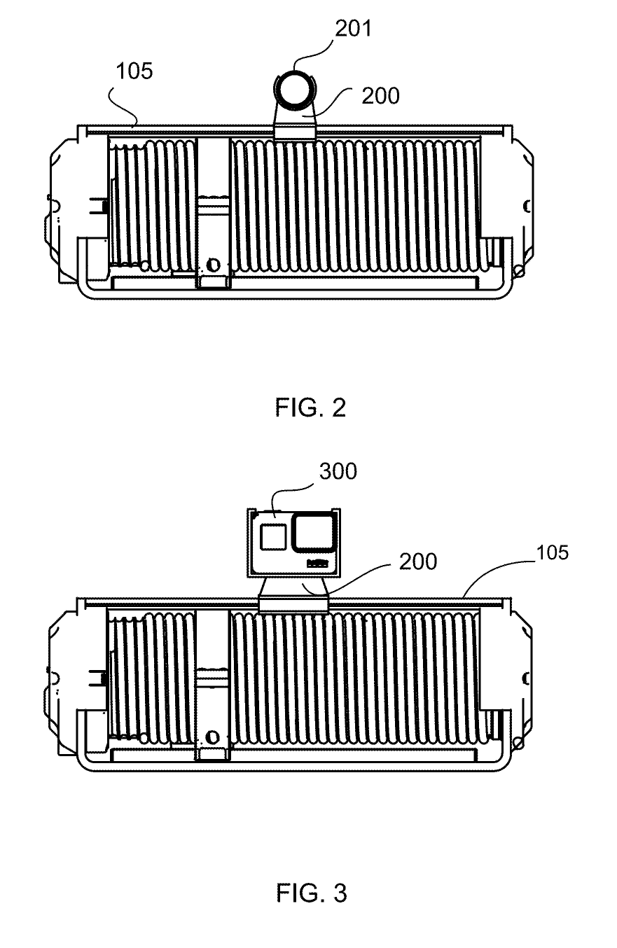

FIG. 3 is a front view of the winch 100 with an auxiliary clip 200 attached to the power bar 105 and holding a camera 300. The auxiliary clip 200 may be fitted to many different hardware, including phones, spotlights, headlights, radios, speakers, air compressors, heaters, water pumps, and power supplies.

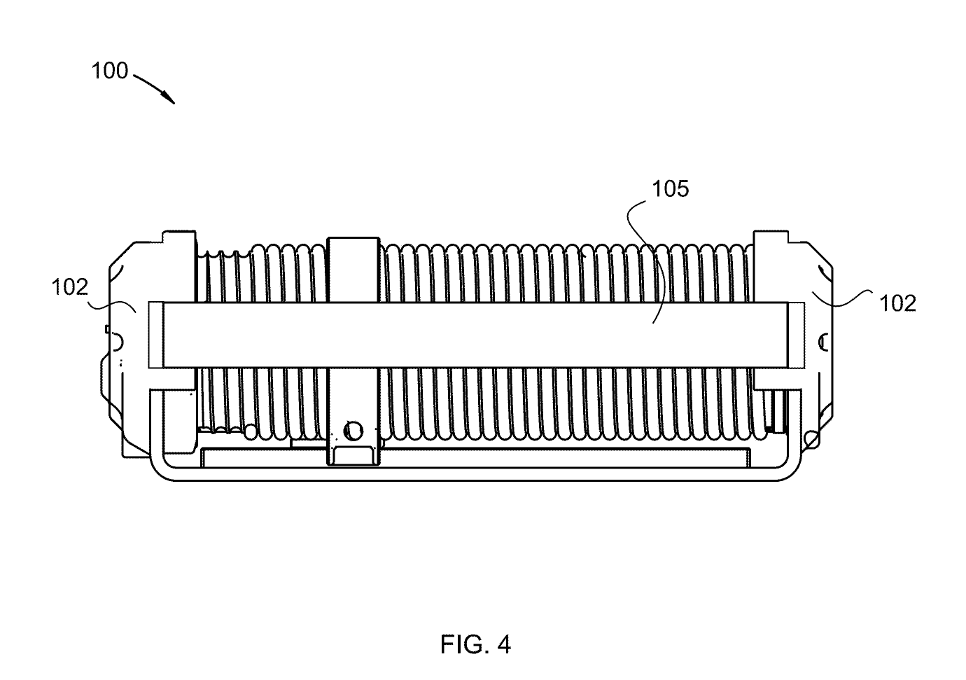

FIG. 4 depicts a winch assembly 100 with a power bar 105 attached to the front of the winch. The power bar 105 may be placed anywhere between the first and second end brackets 102, provided that it is attached to both end brackets 102.

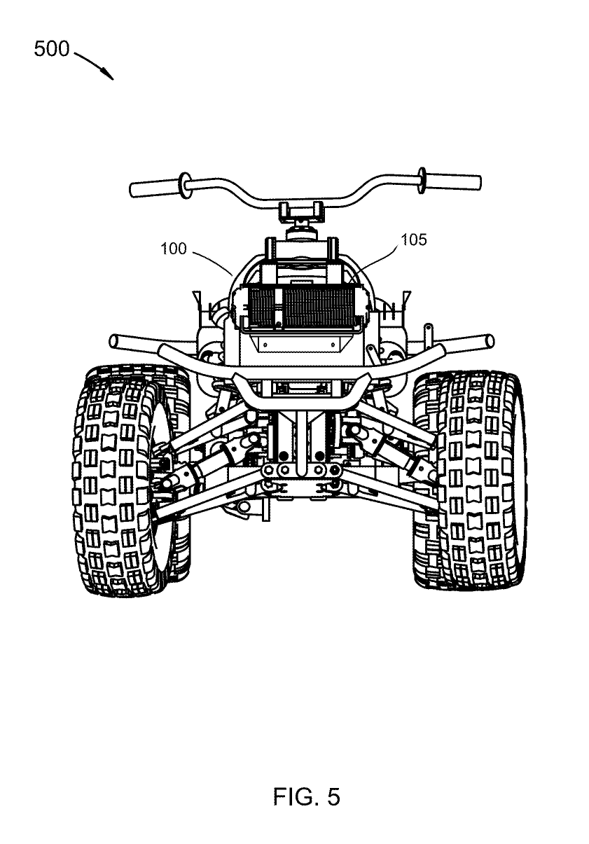

FIG. 5 depicts a winch assembly 100 mounted on a ATV 500. The winch assembly 100 can be mounted upon many different vehicles because it is detachable. A winch assembly 100 can fit an automobile, a tractor, a truck, a boat, a tank, an armored fighting vehicle, a military engineering vehicle, an ambulance, a train, a draisine, or a reconnaissance vehicle. This is extremely useful because a winch assembly 100 is designed to pull a large variety of things in a large variety of situations, and because the winch assembly 100 can attach to different vehicles, it becomes useful in many more situations. For example, a winch assembly 100 could attach to a truck and be used to pull a tree trunk out of the ground. It could be attached to an ATV 500 to pull an object stuck in mud out of the mud. As shown, the winch 100 may power one or more accessory devices (e.g., lights, cameras, etc.) via the power bar 105 as described herein. A winch assembly 100 might also be attached to an automobile and then used to pull another automobile. A winch assembly 100 might also be attached to an automobile, ATV, truck, or tractor to fell a tree, or to pull a boat out of water. The winch assembly 100 is removably attached to a vehicle so that it can be attached to any one vehicle, used, then removed, and attached to another vehicle for a different purpose. Additionally, the winch 100 may be attached to a non-vehicle.

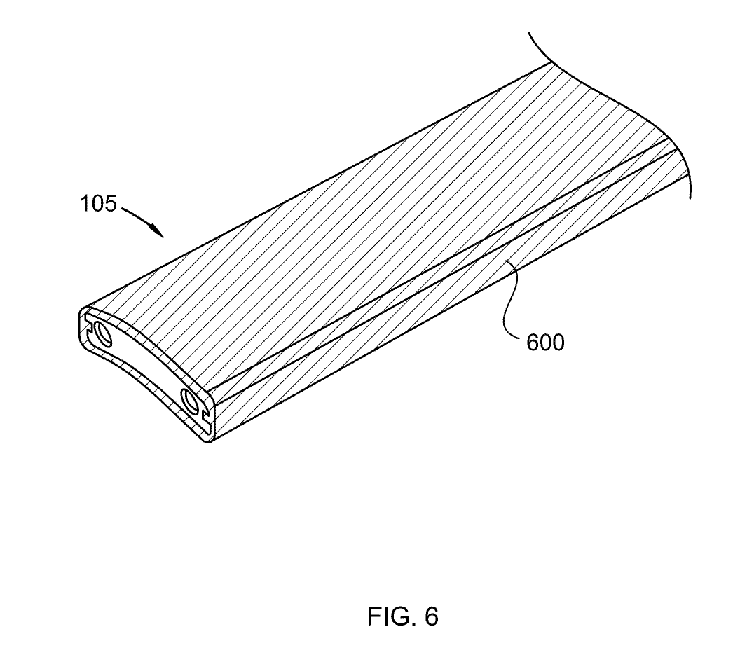

FIG. 6 shows a side view of a power bar 105 encased in a protective cover, 600. The protective cover 600 may be made of different materials or a combination of materials. The cover 600 is electrically insulating and could be made from rubber, plastic silicone or a combination thereof. The cover 600 can be used to protect the power bar 105 from different natural elements such as rain, snow, sleet, hail, the sun, or mist.

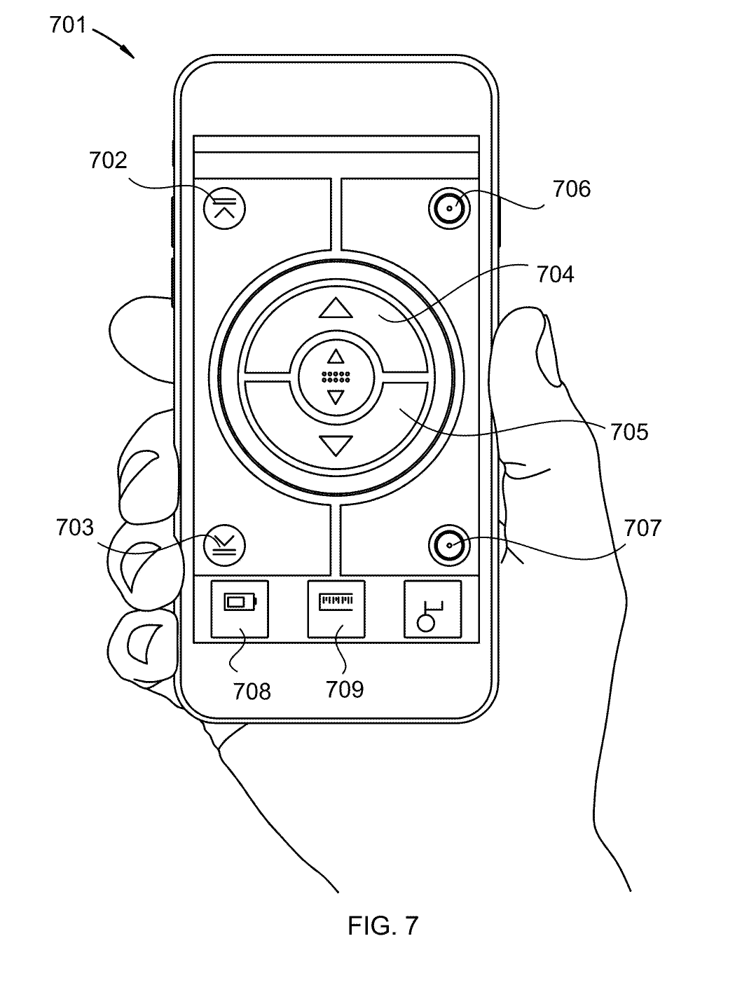

FIG. 7 depicts an app related software on a mobile phone 701. The app can control the winch by short-range wireless connection, which may include Bluetooth. The app 700 comprises many features, such as an all out button 702 and an all in button 703. When engaged, the all out button 702 signals to the winch 100 to wind all the cable 104 off of the drum 103. This prevents the user from having to hold a button for a long period of time when wanting to unwind all the winded cable 104 off the drum 103. Similarly, the all in button 703 signals to the winch 100 to wind all the cable 104 onto the drum 103. When a user knows that they are finished with the winch 100 and want to store all the cable 104 onto the drum 103, they do not need to hold a button for an extended period of time, rather they press the all in button 703 once and all the unwinded cable 104 winds onto the drum 103. A variable speed control button 704 allows a user to increase the speed at which the cable 104 winds onto or off the drum 103. As such, a user will spend less time waiting for the cable 104 to wind back onto the drum 103, whether when the winch 100 is not attached to or pulling any object, or when it is. When the winch 100 is pulling an especially light object, a user may be inclined to wind it faster onto the drum 103. A second variable speed control button 705 allows a user to decrease the speed at which the cable 104 winds onto or off of the drum 103. This feature is particularly helpful if the winch 100 is pulling a very heavy object. A user selectable preset button 706 permits a user to preselect the amount of cable 104 they would like the winch assembly 100 to unwind off the drum 103. A second user selectable preset button 707 permits a user to have a second predetermined amount of cable 104 that will unwind off the drum 103 when engaged. Hence, if a user is using the winch assembly 100 to pull an object repeatedly that always requires the same amount of cable 104, a user doesn't need to manually measure the amount of cable 104 each time, rather, they can preset the length of cable 104 they need using the user selectable preset button 706 or 707 and simply engage the button every time they need the predetermined amount of cable 104.

In one embodiment, the user selectable preset button 706 may be used to power on the power bar 105 (or power on a particular device or particular outlet on the power bar, for example) and the selectable preset button 707 may be used to power off the power bar 105 (or power off a particular device or particular outlet on the power bar, for example). In this way a user may easily select and control which devices on the power bar 105 (or the power bar 105 itself, for example) are powered on/off.

A battery indicator button 708 indicates to the user how much battery life the winch assembly 100 has remaining. Because the winch assembly 100 can operate solely on battery power, a user does not need to be near an electrical outlet to use their winch assembly 100. However, if the battery life is running low, a user will need to find an electrical power source to continue using their winch assembly 100. As such, the battery life indicator button 708 signals to a user how much power is remaining. The battery can be recharged at any time. A load indictor button 709 signals to the user the weight of the load that the user is pulling. The winch assembly 100 has the capacity to pull up to 2,000 lbs. and the load indicator button 709 will indicate to a user how much of this capacity is being used when pulling an object. This will be helpful to a user in the event that they need to determine whether or not they can add more weight for the winch assembly 100 to pull.

In some embodiments, the winch assembly 100 may have the capacity to pull up to 4,000 lbs for a very short amount of time (e.g., less than 5 seconds), by allowing the winch assembly 100 to draw substantially more current (in a short burst, for example), than is permitted in steady state (or typical) operation. In some cases, this burst of pulling power may enable the winch 100 to overcome the static friction of a heavy object while being able to overcome the moving friction using a pulling capacity that is less than the 2,000 lb pulling capacity. This may enable the winch 100 to be able to accomplish certain tasks that would otherwise be unattainable with the 2,000 lb pulling capacity. In some cases, this burst mode capacity may be enabled via a button (e.g., load indicator button 709, by long pressing the button, for example).

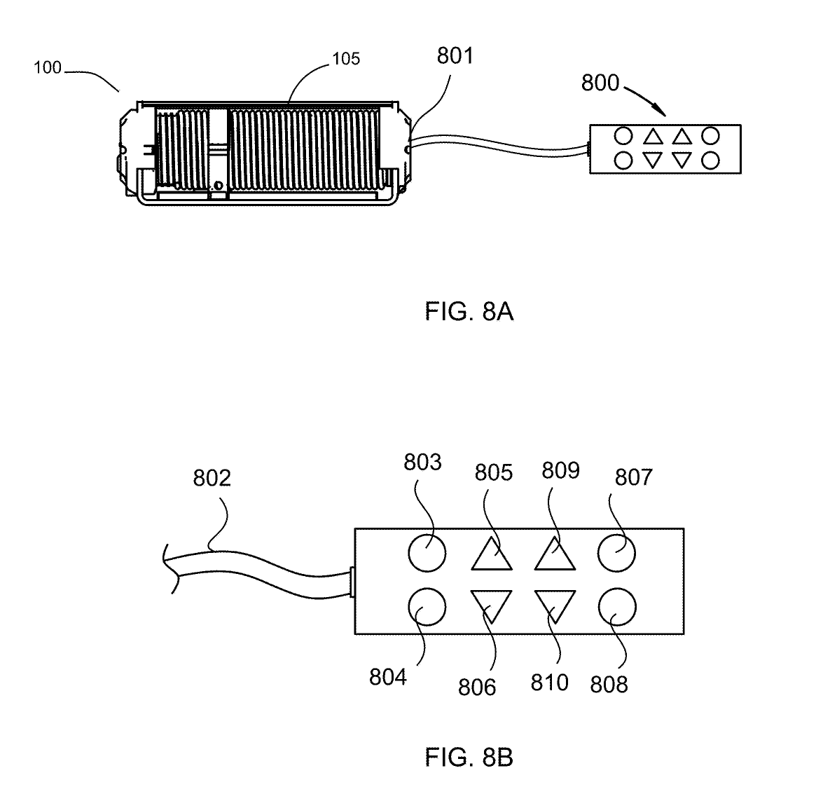

FIG. 8A depicts the winch assembly 100 attached to a remote controller 800. The remote controller 800 is plugged into the endcap 102 via an auxiliary port 801, and allows a user to control the winch assembly 100. This remote controller 800 would be useful for a user who does not have a mobile phone 701, or who does not have a mobile phone 701 with short range-wireless connection capabilities. Under such circumstances, a user will still need a way to operate the winch assembly 100. Hence, the remote controller 800 also connects to the controller 109 and allows a user to give commands to the winch assembly 100.

FIG. 8B shows a close-up view of the remote controller 800. A connecting cable 802 allows the remote controller 800 to plug into the winch assembly 100 auxiliary port 801, and allows for an electrical signal to reach the controller 109 and command the motor 106. When engaged, the all in button 803 signals to the winch 100 to wind all the cable 104 on to the drum 103. This prevents the user from having to hold a button for a long period of time when wanting to wind all the unwinded cable 104 onto the drum 103. Similarly, an all-out button 804 signals to the winch assembly 100 to unwind all the cable 104 off the drum 103. A variable speed control button 805 allows a user to increase the speed at which the cable 104 winds onto or off the drum 103. As such, a user will spend less time waiting for the cable 104 to wind back onto the drum 103, whether when the winch 100 is not attached to or pulling any object, or when it is. When the winch assembly 100 is pulling an especially light object, a user may be inclined to wind it faster onto the drum 103. A second variable speed control button 806 allows a user to decrease the speed at which the cable 104 winds onto or off the drum 103. A user selectable preset button 807 permits a user to preselect the amount of cable 104 they would like the winch assembly 100 to unwind off the drum 103. A second user selectable preset button 808 permits a user to have a second predetermined amount of cable 104 that will unwind off the drum 103 when engaged. A wind on button 809 permits a user to signal to the winch assembly 100 to wind the cable 104 onto the drum 103, while a wind off button 810 permits a user to command the winch assembly 100 to wind the cable 104 off of the drum 103.

1. A winch assembly, comprising:
a winch frame having a first end bracket and a second end bracket;
a winch drum disposed within the frame between the first end bracket and the second end bracket;
a motor located within the drum;
a gear assembly connected to the motor;
a winch cable windably connected to the winch drum;
a power bar comprising:
a rigid cross bar bridging the winch drum, and attached to the first end bracket and the second end bracket,
electrical contacts within the cross bar, electrically coupled to an electrical power source;
wherein the power bar is configured for mounting and powering auxiliary devices;
wherein, as the auxiliary devices are mounted, they automatically connect to the electrical contacts.

2. The winch assembly of claim 1, further comprising a clip for mounting the auxiliary device to the power bar, wherein the clip comprises spring loaded side flanges and connection.

3. The winch assembly of claim 2, wherein the auxiliary device is selected from the group consisting of cameras, phones, flashlights, spotlights, headlights, radios, speakers, air compressors, heaters, water pumps, and power supplies.

4. The winch assembly of claim 1, wherein the winch frame comprises a handle.

5. The winch assembly of claim 1, wherein an exterior surface of the winch drum comprises one or more spiral grooves for controlling the winch cable as it is wound and unwound on the winch drum.

6. The winch assembly of claim 1, wherein the winch frame is removably attached to a vehicle.

7. (canceled)

8. The winch assembly of claim 1, wherein the winch cable is comprised of one or more of the following: steel, polyethylene, fiber based polyethylene, and synthetic fiber.

9. The winch assembly of claim 1, wherein the gear assembly comprises electronic controls.

10. The winch assembly of claim 1, wherein the power bar comprises an electrically insulating cover comprising rubber, plastic, silicone, and combinations thereof.

11. The winch assembly of claim 1, wherein the winch assembly is adapted to receive commands from a controller comprising manual and app related software.

12. The winch assembly of claim 11, wherein the app related software comprises an all-in command and an all-out command for winding and unwinding the entire winch cable onto and off the drum.

13. The winch assembly of claim 11, wherein the app related software comprises a cable winding speed control for controlling the speed of the drum as the cable is wound on and off the drum.

14. The winch assembly of claim 11, wherein the drum comprises a load sensor in communication with the controller for measuring a load on the winch cable as the cable is wound onto the drum.

15. The winch assembly of claim 11, wherein the controller comprises a preset winch cable load threshold, and wherein the winch assembly will not operate if a load exceeds the load threshold.

16. The winch assembly of claim 15, wherein the winch cable load threshold is up to 2,000 lbs.

17. The winch assembly of claim 1, wherein the end brackets comprise a pairing button that when activated seeks and connects the controller with a nearby cellular device.

18. The winch assembly of claim 11, wherein the app related software comprises user selectable presets for distributing a length of winch cable.

19. The winch assembly of claim 1, wherein a winch motor is disposed within the winch drum; and wherein a gear assembly is disposed within the winch drum and attached to the motor and the drum such that operation of the winch motor and the gear assembly cause the winch drum to rotate.

20. The winch assembly of claim 1, further comprising a battery, wherein the battery powers a winch motor; and wherein the winch assembly further includes burst mode circuitry that enables a burst mode current for a predetermined duration.

21. The invention of claim 1, wherein the electrical contacts are induction coils.
